(19) United States
(12) Patent Application Publication
(10) Pub. No.: US 2009/0294244 A1
(43) Pub. Date: Dec. 3, 2009

(54) Currency Validator with Rejected Bill Image Storage

(76) Inventors: Harold Charych, Poquott, NY (US); Thomas W. Mazowiesky, Patchogue, NY (US); Miroslaw Blaszczec, Lindenhurst, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/130,511

(22) Filed: May 30, 2008

(51) Int. Cl. G07F 7/04

(52) U.S. Cl. 194/206

(57) ABSTRACT

A currency validator having capability to record and store the image of rejected bills inserted into a currency validator, permitting the operator to determine the reasons for bill rejection.

### TECHNICAL FIELD

The present invention relates to the field of currency validators and more specifically to the system of a currency validator having the capability to record and store the image of rejected bills inserted into the currency validator.

### BACKGROUND

Currency validators are now used in most countries around the world in various applications to identify and authenticate banknotes. Early currency validator units in the United States utilized the magnetic signatures of notes to distinguish and validate US currency for vending applications. As demand for currency validators that recognize international currency grew, new currency validators incorporating optical sensor technology were introduced.

Currency validators incorporating optical sensor technology typically consisted of one or more photo detectors sensing light from a LED, bulb, or other light source either transmitted through, or reflected from currency. Early units utilized a limited number of light sources, but recent units are capable of utilizing multiple light sources.

All of these currency validators feature sensors with fairly low grade resolutions. The bill recognition and security techniques that are used in these systems are uniquely qualified to be machine recognizable and do not mimic the method used by human recognition of notes. These systems work by digitizing the light patterns as the bill passes over the sensor and then analyzing these patterns and digitally comparing them to data stored in the memory of the unit. The data in the memory typically represents the patterns of known good notes that have been scanned previously, and the unique identifying information isolated and processed for later recognition and security examination.

It is possible that users of these machines may insert notes that the currency validator cannot recognize. As a simple example, a US citizen traveling in Europe might accidentally insert a US note into a vending machine that recognizes only Euros. The machine will reject his note as the US notes do not resemble the stored information for a Euro note. When this rejection is complete, a record is kept of the fact that a note was inserted and not recognized by the validator. Since the US note is so different from the Euro note, it is relatively easy for the machine to determine that it is not a note that should be recognized. However, when the owner of the machine reviews machine performance, the reason this note was rejected will not be readily apparent. Typically currency validators will record limited information of rejected notes—given the large number of currencies available; the ability of the machine to record detailed information about the type of rejected note inserted into the machine is limited. Normally, currency validators only store limited, basic information. For example, the machine will keep a record of the number of notes it rejected.

Thus, the operator gets no information about how the validator in an application or machine is operating. Worldwide acceptance rates for currency validators vary from country to country, but operators hope to get 95% or better rates for correct, undamaged currency. Now as can be seen from the example above, a customer who inserts an incorrect note or a mutilated note in poor condition, which gets rejected multiple times in a machine, can severely impact the acceptance rate. The manufacturer of the validator also does not have information available about what is causing poor performance in certain applications. There are also occasions when counterfeit notes are used in a deliberate attempt to fool the validator. In some instances a counterfeiting ring may try to attack what appears to be an inviting target such as a casino. Casinos typically have hundreds of games with validators. These machines are vulnerable as they typically accept high denomination notes with relatively little security. While there are many cameras around a casino floor, the resolution of these systems is insufficient to determine currency authenticity. Good validators will reject most if not all of these counterfeits, but when reviewing performance data, the operator does not know he has avoided a problem—all he sees is that the validator on a particular shift rejected numerous notes. The operator could then be misled to believe that the particular currency validator was performing poorly.

High resolution scanning technology developed by Global Payment Technology is described, for example, in U.S. patent application Ser. No. 11/473,368, which disclosure is fully incorporated herein by reference. This technology has been incorporated into the present invention. This technology allows sub-millimeter scans to be taken, and currency validators incorporating this high resolution scanning technology can capture data that permit a high resolution picture of a banknote, allowing new and improved applications such as being able to convey to the user validator performance.

Among other things, this invention provides the operator and the validator manufacturer the ability to determine the incidence of incorrect notes, fraud notes, etc., that are included in the rejection category. The invention enables the validator manufacturer to screen out the rejects for incorrect notes, mutilated notes and isolate the remaining rejects into security violations (fraud insertions) and database outliers (good notes that are rejected for wear). The invention provides a method to incorporate this information into subsequent releases of the product to improve the acceptance of good notes in validators.

### SUMMARY OF THE INVENTION

The present disclosure provides a currency validator having the capability to record and store images of rejected bills inserted into the currency validator, permitting the operator to determine the reasons for the rejection of a particular bill.

In one aspect of the present disclosure, a currency validator is comprised of a note transporter module, a data collection module, and a processing module.

A second aspect of the present disclosure includes a currency validator comprising a channel configured to accommodate a note, a note transporter module configured to transport the note through the channel, at least one illuminator configured to illuminate a width of the channel, a photodetector array, a lens associated with the photodetector array, an internal memory configured to store data collected from the photodetector array, and a removable storage medium, placed in communication with the internal memory.

A third aspect of the present disclosure includes a currency validator comprising a channel configured to accommodate a note, a transporter configured to transport the note through the channel, a photodetector array, at least one illuminator configured to illuminate a width of the channel, a lens associated with the photodetector array, a memory store configured to store data collected from the photodector array, and a communications means connected to the memory store allowing the data from a rejected note to be transferred to a storage medium outside the validation device.

Some of the objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate at least one embodiment of the invention and together with the description, serve to explain the principles of the invention.

### BRIEF DESCRIPTION OF THE DRAWINGS

The accompanying drawings, which are incorporated in and constitute a part of this specification, illustrate at least one embodiment of the invention and together with the description, serve to explain the principles of the invention.

FIG. 1 is a side view of a high resolution scanning system of a currency validator, according to an exemplary disclosed embodiment.

FIG. 2 is a schematic diagram of a linear array and a processing module, according to an exemplary disclosed embodiment.

FIG. 3 is a flow chart of a currency validation process.

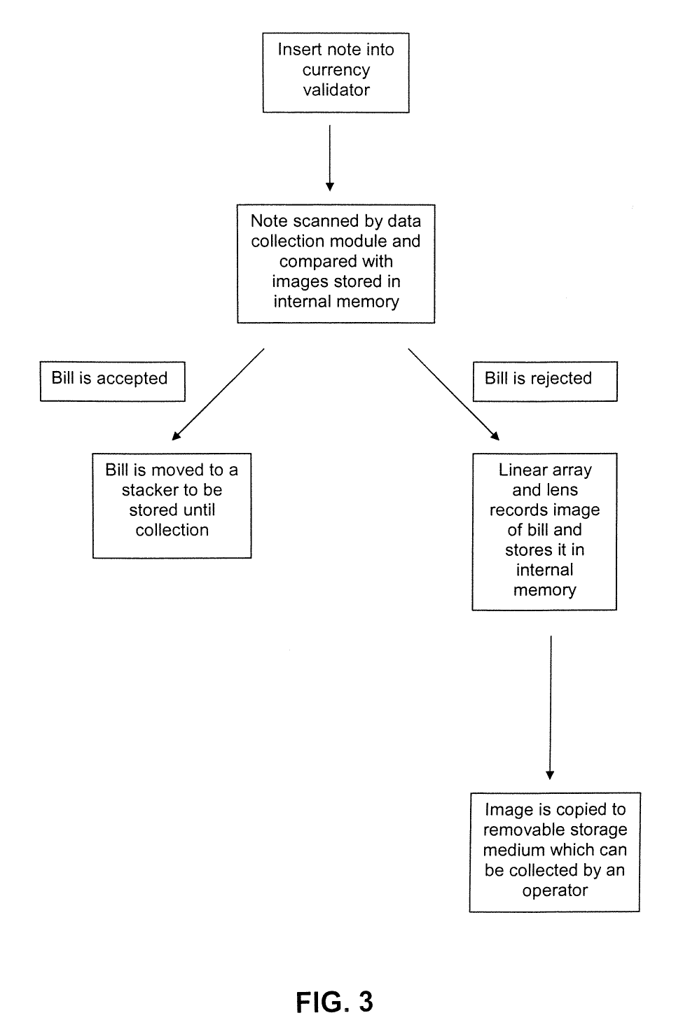

### DETAILED DESCRIPTION OF THE DRAWINGS

Reference will now be made in detail to the exemplary embodiments of the invention, examples of which are illustrated in the accompanying drawings. Wherever possible, the same reference numbers will be used throughout the drawings to refer to the same or like parts.

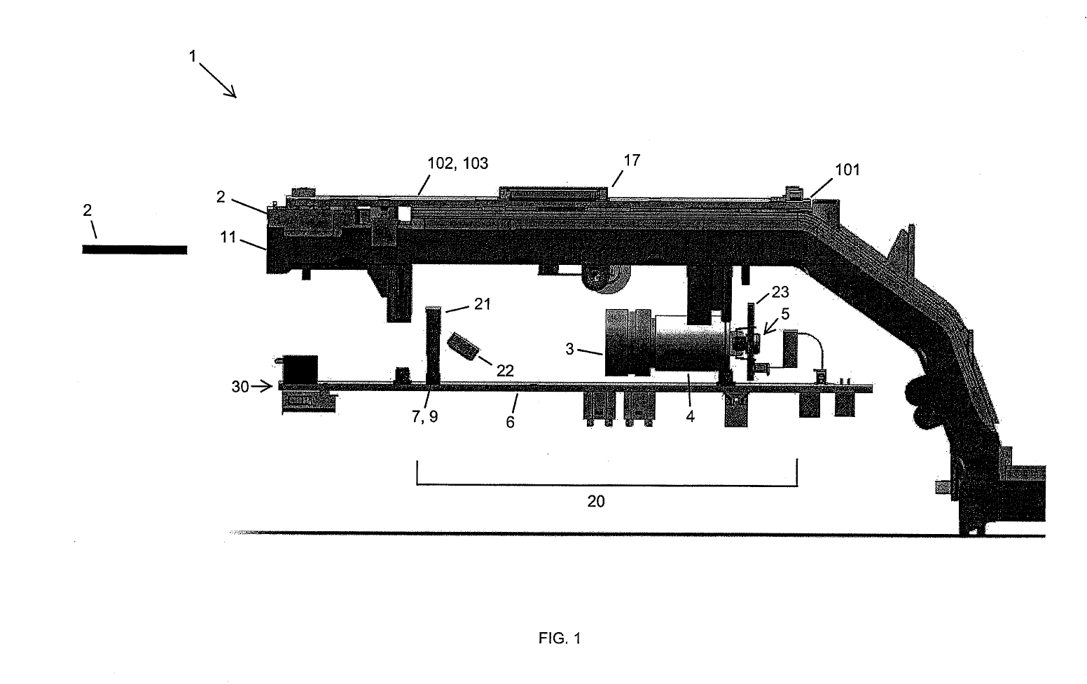

FIG. 1 a side view of a high resolution scanning system of a currency validator, according to an exemplary disclosed embodiment. As shown in FIG. 1, the currency validator 1 comprises several components, including one or more of a note transporter module 10, a data collection module 20, and a processing module 30.

Note transporter module 10 may be any suitable note transporter known in the art. Note transporter module 10 may be configured to transport note 2 through note channel 11 in any suitable direction using any suitable means, for example, by rollers or belts. The rollers or belts may be actuated via an attached motor (not shown). Note channel 11 may be at least as big in dimension (length, width, and height) as the largest currency note in circulation; however, note channel 11 may have any suitable dimensions in the length, width, and height directions. Note transporter module 10 may be constructed of an opaque material such as black ABS plastic. However, note transporter module 10 may be constructed of other suitable materials including, but not limited to, plastic, glass, or metal which may be opaque or transparent. Note transporter module 10 may include transmission window 8, which may be disposed between note 2, and lens 3 and/or linear array 5. Note 2 may be transported through note transporter module 10 at a rate such that a specific number of lines of note 2 may be scanned (e.g., one line for each wavelength may be scanned every 0.6 mm of note 2). The rate may be incremental or substantially continuous.

A data collection module 20 may comprise multiple components. In one embodiment, a data collection module 20 includes a printed circuit board 6 on which various components may be attached. The printed circuit board 6 may be mounted substantially parallel with a bottom surface of note transporter module 10 and/or a plane including note 2 as it travels through note channel 11, however, any suitable configuration that allows scanning of note 2 will suffice. Printed circuit board 6 may include any number of components necessary to scan and process a note 2, for example, light pipe 21, fold mirror 22, and LEDs 7, 9.

Lens 3 may be mounted to lens mount 4, which may in turn itself be mounted to printed circuit board 23. A linear array 5 may be configured on the printed circuit board 23. Lens 3 may be mounted such that an entire width of note channel 11 is viewable by linear array 5, for example, via transmission window 8. The distances between lens 3, linear array 5, and note 2 may be jointly or independently set and controlled by any suitable mechanism and/or method. Lens 3 may be configured such that an entire width of note channel 11 is focused on linear array 5, even if linear array 5 has a width that is less than a width of note channel 11.

Linear array 5 may be any suitable note scanning array. The linear array 5 is a row of sensors configured to take a simultaneous scan of a line of an object, e.g., an entire width of a note 2. This is in contrast to individual photo detectors used in conventional currency validators, which are only configured to scan and collect data relative to one point of note 2. Even a plurality of individual photo detectors can only scan a plurality of points, and not an entire line of data.

An example of a linear array 5 that may be used includes a TSL1401R, 128×1 array manufactured by TAOS INC. The TSL1401R is well adapted for use in note scanning. Some generally desirable features of a linear array 5 which the TSL1301R possesses includes a good response to a wide frequency range (e.g., between about 350 and about 980 nm), a wide dynamic range (e.g., about 72 dB), a linear response across the array (e.g., <4%), a pixel readout frequency of about 8 MHz, and a sufficient number of pixels across the array (e.g., 128) to give sub-millimeter resolution without generating excessive data. Each pixel on the array may be specified to be within about +/−7.5% of the average of all pixels in the array, over temperature. Linear array 5 may be configured to scan a note 2 having a width of about 8 mm (i.e., about a width of linear array 5 itself) up to at least a note 2 having a width of about 90 mm (i.e., suitably width enough to accommodate substantially all paper currencies). Each pixel may scan a line of note 2 having a width in a direction of travel of note 2 of about 0.67 mm. Accordingly, linear array 5 may scan a line of note 2 about every 0.6 mm per wavelength. The device is physically small, inexpensive and is well adapted to use with commercially available lenses, thereby reducing overall costs for use in a note validator. The device can be used over a wide voltage range, making it suitable for use, for example, with both 5 volt and 3.3 volt based systems.

The currency validator 1 and/or data collection module 20 may include one or more illuminators or sets of illuminators such as LEDs 7, 9 used to illuminate transmission window 8. One set of LEDs 7 may be configured to emit light having a frequency different from a second set of LEDs 9. LEDs 7, 9 may also or alternatively be connected and controlled such that only one set of LEDs which emit light at one frequency may be illuminated at any point in time. As an example, LEDs 7 may be 660 nm red LEDs, and LEDs 9 may be 880 nm infrared LEDs. At any one time, LEDs 7 and/or LEDs 9 may be illuminated. Additional colors can be added and/or selected by adding more LEDs and/or control signals, for example, blue (470 nm) or green (565 nm). However, LEDs 7, 9 may emit any color, for example, red, infrared, ultraviolet, or any other wavelength in the visible or non-visible spectrum.

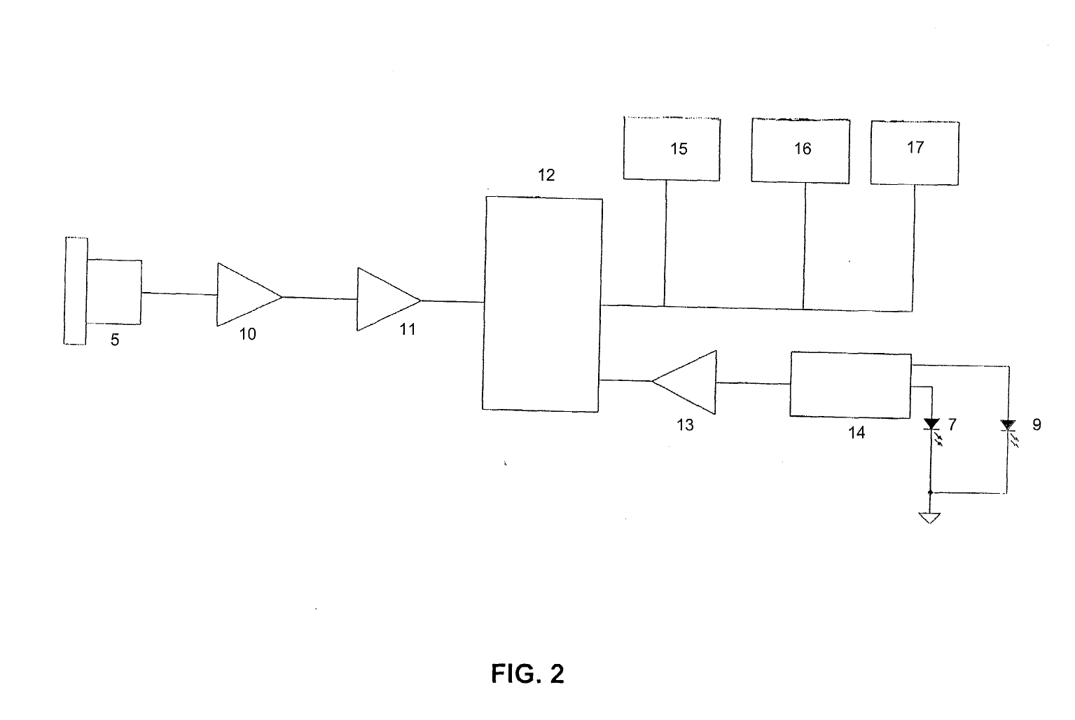

FIG. 2 illustrates the linear array 5 and the various components of the processing module 30. The processing module 30 may include a printed circuit board 6 and one or more of amplifier 10, (Analog-to-digital) A/D converter 11, CPU 12, (Digital-to-analog) D/A converter 13, and LED driver circuitry 14. Processing module 30 may control components of the data collection module 20: including, one or more of LEDs 7, 9, linear array 5, and lens 3.

A combination of CPU 12, D/A converter 13, and LED driver 14 may control LEDs 7, 9. For example, CPU 12 may be used to set the intensity and/or duration of light output from LEDs 7, 9. A digital signal indicating such may thus be sent from CPU 12 to D/A converter 13, which may convert the digital signal into an analog signal, and then that signal may be sent to LED driver 14, which in turn will control the intensity and duration of light out from LEDs 7, 9 at the predetermined levels. In another example, CPU 12 may be used to determine which set of LEDs 7, 9 are illuminated. CPU 12 may send a signal COLOR to LED driver 14 indicating that only one color set of LEDs 7, 9 are to be illuminated at a given time. LED driver 14 will thus illuminate the proper set of LEDs 7, 9. Choosing which set of LEDs 7, 9 to illuminate may be a function of several factors, for example, the color and composition of note 2 being scanned. In operation, as note 2 moves through note channel 11, LEDs 7, 9 may be illuminated on alternate exposure cycles by LED driver 14, which may result in a multi-color scan of note 2. For example, for a two color scan of note 2, a line of note 2 will be read about every 0.3 mm, alternating wavelengths of LEDs 7, 9, resulting in one scan for each wavelength every 0.6 mm. Additional colors can be added and/or selected by adding more LEDs and/or control signals, for example, blue (470 nm) or green (565 nm). No matter how many color(s) are used, however, the process of scanning may be consistent.

A combination of CPU 12, A/D converter 11, and amplifier 10 may control and/or receive data scanned from note 2 by linear array 5. Specifically, linear array 5 may be functionally connected to CPU 12 through signals STROBE and CLK. For example, in order to signal to linear array 5 to scan (e.g., capture light) note 2 and/or note channel 11, CPU 12 may set the STROBE function on high and send that signal to linear array 5. Linear array 5, being a scanner, may then turn “on” and begin to scan data reflected and/or transmitted from note 2 and/or note channel 11 from one or more of LEDs 7, 9. Once CPU 12 has determined that linear array 5 has been sufficiently exposed to note 2 and/or note channel 11, CPU 12 may set the STROBE function on low, and send the signal to linear array 5 to end scan. The timing between these STROBE signals may be used to control the amount of time linear array 5 is exposed to note 2 for each scan. Such exposure time may have been set and/or previously determined as necessary to provide sufficient light to linear array 5 from note 2 that can be converted into useful data.

For example in one illustrative embodiment using three LED colors, one exposure can be taken per 0.6 mm of length of note. This causes a slight overlap between pixels along the note so that there are no gaps between pixels. Using 3 colors, an exposure is taken in red, the note moves 0.2 mm during the exposure, then an exposure is taken in Blue, the note moves 0.2 mm during the exposure, then an exposure in IR, the note moves 0.2 mm, and the next exposure would be in Red again. More colors can be used if the exposure time is shortened such that a total time for all the colors is still less than the size of the pixel (such as 0.67 mm in the TSL1401R array) given the reduction factor used (about 10.5-11x). Accordingly, given a 150 mm long note 223 exposures per color (150/0.67) can occur.

Between the aforementioned settings of STROBE functions on high and low, linear array 5 may receive and convert light from note 2 and/or note channel 11 into analog data, and may hold that analog data in holding registers of linear array 5. CPU 12 may then clock CLK and send that signal to linear array 5. With each CLK signal, linear array 5 may send the data stored in holding registers to amplifier 10 as signal PIXELS. Signal PIXELS may be amplified and buffered by amplifier 10, and then sent to A/D converter 11. A/D converter 11 may sample the input, convert the analog signal into a digital representation of the input, and present the digital representation of signal PIXELS to CPU 12. CPU 12 may then store PIXELS in internal memory 16. This process may be repeated until all pixels of the array have been processed.

By controlling the STROBE and CLK signals, CPU 12 and/or linear array may provide the capability of clocking out the electrical signal while capturing the next exposure, e.g., line of scanned data from a width of note 2, thus providing a continuous sampling and conversion process.

Currency validator 1 shown in FIGS. 1 and 2 is primarily configured to scan data (e.g., light) reflected from note 2. For example, light is transmitted from one or more of LEDs 7, 9 through transmission window 8, reflected off a surface of note 2 back through transmission window 8 onto lens 3, and then focused onto linear array 5 using lens 3.

Alternatively, a second set of independent LEDs (e.g., transmissive LEDs 102, 103 mounted on frame 101), mounted on a side of note transporter module 10 substantially opposite to linear array 5 and the first set of LEDS 7, 9, may be used to illuminate note 2. The light passing through note 2 from this second set of LEDs 102, 103 may be scanned by linear array 5 in substantially the same way that reflected light is scanned using the first set of LEDs (e.g., reflective LEDs 7, 9) mounted on the same side of note transporter module 10 as linear array 5. The second set of LEDs 102, 103 may be illuminated when the first set of LEDs 7, 9 are turned off, and the first set of LEDs 7, 9 may be turned on while the second set of LEDs 102, 103 are turned off.

Once the note has been scanned the processing unit now proceeds through the steps of recognizing and validating the note. When a note is verified, it is typically stored in a box or stacker that secures the note until the stacker is collected at a later time. Should the note not verify, rather than just rejecting the note, the validator takes the information gathered from the sensor that is stored in internal memory 16 and transfers this information preferably to an easy to access removable storage medium 17. The removable storage medium 17 may include a SD card, a compact flash card, a USB drive, or any other portable storage medium known in the art.

Removable storage medium 17 is connected to the processing system through a connector that allows the card to be easily inserted and removed from the currency validator 1. Removable storage medium 17 will preferably have a file system access method that allows the card to be quickly read by a PC. Data on the removable storage medium 17 would be arranged in files, with each file representing a single instance of a rejected insertion. The data on the removable storage medium 17 would be read by the database designers at the manufacturer. This data can be read by physically transporting the removable storage medium 17 to the manufacturer, or by transmitting the data on the removable storage medium 17 to the manufacturer.

Data from the removable storage medium 17 would be displayable on a PC used by the operator to allow the operator to quickly look at the rejected bill images and render a quick determination as to number of notes rejected for incorrect currency (country or non-accepted denomination), mutilated notes, and rejects from other causes. When the data from the removable storage medium 17 is transferred to the manufacturer, the manufacturer may do further analysis of the contents.

Data from the removable storage medium 17 can be compared directly with the data that makes up the particular database. By comparing this data with the database information the manufacturer can determine precisely why a particular note was rejected. As an example, in the case of a very worn note, the data taken would in some instance be outside the acceptable limits set in the database. After analysis, a determination would be made by looking at the image visually and then the numerical difference and making a judgment on whether this particular insertion represents an outlier (unusual representative of the real population) or whether the insertion should be included in the database. Depending on the results of the analysis, the manufacturer may decide to take data from the rejects and incorporate it into the database, or may decide to reject expanding the acceptance of the database.

As an example, data from a reject would be run through the same process as in the validator, and an operator can monitor what test or tests causes the note to fail. After testing, the operator can modify the database using the new information—expanding the database to include that newest information. This allows a much wider set of good data for the database to be collected and used to develop the database. Since the user is supplying the data, no one needs to be dispatched to collect data, reducing or eliminating travel budgets to collect data.

In addition, since fraud data can also be collected in this way, careful analysis of the data can detect fraudulent activity. Typical counterfeits do not stay long in circulation. They are usually detected and removed from the at large population. Since they are so quickly removed from the population, they tend to have much less wear on them than real notes. Software can do an analysis of multiple scans of rejected notes from many machines to see if there are identical (or nearly so) scans for rejects. Since these scans will be the same except for direction, it should be possible to detect the similarity among the scans and flag it for an operator to check.

With the removable storage medium 17, a displayable image can be made at any time, permitting the operator or the manufacturer the opportunity to view high resolution, multi-spectral scans of the object. The operator can determine if the note was real or fraudulent, and adjust the failure rate accordingly. This permits a true evaluation of the performance of the validator to be made, since the operator and manufacturer now have all the data needed to make a determination.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A currency validator comprising:
a note transporter module for transporting a note;
a data collection module having a photodetector array for scanning the note; and
a process module having an internal memory for storing data collected from the photodetector array.

2. The currency validator of claim 1, wherein the note transporter module comprises at least one of a not channel, a transmission window, and a note transport mechanism.

3. The currency validator of claim 2, wherein the note transport mechanism comprises at least one of a roller or a belt.

4. The currency validator of claim 1, wherein the data collection module comprised at least one of a printed circuit board, a lens a lens mount/light shield, and LEDs.

5. The currency validator of claim 1, wherein the processing module comprises at least one of an amplifier, an analog-to digital converter, a CPU, a digital-to-analog converter, and LED driver circuitry.

6. A currency validator comprising:
a channel configured to accommodate a note;
a note transporter module configured to transport the note through the channel;
at least one illuminator configured to illuminate a width of the channel;
a photodetector array configured to scan the note;
a lens associated with the photodetector array;
an internal memory configured to store data collected from the photodetector array; and
a removable storage medium, placed in communication with the internal memory, configured to transfer the data stored in the internal memory.

7. The currency validator of claim 6, wherein the note transporter module comprises at least a roller or a belt

8. The currency validator of claim 6, wherein the lens and the at least one illuminator are arranged to provide optical data collected from the width of the channel to the photodetector array.

9. The currency validator of claim 6, wherein the illuminator comprises at least one LED.

10. The currency validator of claim 6, wherein the removable storage medium comprises a SD card.

11. The currency validator of claim 6, wherein the removable storage medium comprises a compact flash card.

12. The currency validator of claim 6, wherein the removable storage medium comprised a USB drive.

13. The currency validator of claim 6, wherein the internal memory comprised a hard drive.

14. The currency validator of claim 6, wherein the removable storage medium stores a copy of the data from the internal memory.

15. A currency validator comprising:
a channel configured to accommodate a note;
a transporter configured to transport the note through the channel;
a photodetector array configured to scan the note;
at least one illuminator configured to illuminate a width of the channel;
a lens associated with the photodetector array;
a memory store configured to store data collected from the photodetector array; and
a communications means connected to the memory store for allowing at least a portion of the stored data to be transferred to a storage medium outside the validation device.

16. The currency validator of claim 15, wherein the note transporter module comprises at least a roller or a belt.

17. The currency validator of claim 15, wherein the lens and the at least one illuminator are arranged to provide optical data collected from the width of the channel to the photodetector array.

18. The currency validator of claim 15, wherein the illuminator comprised at least one LED.

19. The currency validator of claim 15, wherein the removable storage medium comprises a SD card.

20. The currency validator of claim 15, wherein the removable storage medium comprises a compact flash card.

21. The currency validator of claim 15, wherein the removable storage medium comprises a USB drive.

22. The currency validator of claim 15, wherein the internal memory comprised a hard drive.

23. The currency validator of clam 15, wherein the removable storage medium stores a copy of the data from the internal memory.
